(19) United States
(12) Patent Application Publication
(10) Pub. No.: US 2013/0230361 A1
(43) Pub. Date: Sep. 5, 2013

(54) ROTATIONAL LOCKING COLLET MACHINE TOOL HOLDER

(71) Applicant: TECHNIKS, INC., Indianapolis, IN (US)

(72) Inventors: John A. Stagge, Indianapolis, IN (US); Michael S. Eneix, Indianapolis, IN (US)

(73) Assignee: Techniks, Inc., Indianapolis, IN (US)

(21) Appl. No.: 13/784,688

(22) Filed: Mar. 4, 2013

Related U.S. Application Data
(60) Provisional application No. 61/606,390, filed on Mar. 3, 2012.

(51) Int. Cl. B23C 5/00

(52) U.S. Cl. CPC B23C 5/00
USPC 409/234

(57) ABSTRACT

A machine tool assembly has a tool holder, a cutting tool, a collet, and a collet nut. The tool holder defines a keyed recess having multiple corners and/or multiple flats formed around an inner surface of the keyed recess. The keyed recess can be integral with the tool holder or can be a separate positioning chuck rotationally and axially secured within the tool holder. The cutting tool is inserted into the collet and has multiple edges and/or multiple flats formed on a keyed end of shank that are matingly received by the keyed recess to prevent relative rotation between the tool holder and the cutting tool and make the cutting tool rotationally and axial fixed within the tool holder. The keyed recess includes a spacer preventing the keyed end of the cutting tool from contacting a base of the keyed recess, thereby preventing radial misalignment of the cutting with the axis of the tool holder from the axial translation and force applied during tightening of the collet nut and collet.

### CROSS-REFERENCE TO RELATED APPLICATIONS

This is a nonprovisional patent application of U.S. Provisional Patent Application No. 61/606,390, filed Mar. 3, 2012, and titled ROTATIONAL LOCKING COLLET MACHINE TOOL HOLDER, which is incorporated herein by reference.

### BACKGROUND

The present invention relates to a machine tool assemblies, and more particularly to a collet chuck machine tool holders for a machine tool spindle.

Many milling machines, machining centers, and other machine tools have a machine tool spindle with a tapered recess for receiving a machine tool holder assembly. A conventional machine tool holder assembly includes a tool holder, a cutting tool, a spring collet, and a collet nut. The conventional tool holder, for example a collet chuck such as those available from Techniks, Inc., of Indianapolis, Ind., includes a tapered machine end that couples with the tool spindle tapered recess. The tool holder generally includes a through hole axially formed through the tool holder, both for receiving the spring collet and the cutting tool on the distal chuck end (tool end), and for supplying coolant from the machine tool spindle to the work piece, either through or around the cutting.

The distal end of the through hole in the tool holder includes a tapered recess or chuck that is shaped to receive and compress the spring collet. The spring collet includes a through bore that receives the shank of the cutting tool. Tightening of the collet nut onto the distal end of the tool holder axially drives the spring collet deeper into the tapered recess, compressing the spring collet radially, and thus clamping the shank of the cutting tool within the interior bore of the spring collet, fixing the cutting tool within the tool holder. Such collet machine tool assemblies also sometimes include a set screw axially installed in the through hole of the holder, for example, behind the collet. The set screw can be used as a stop to adjust the depth within the through hole to which the cutting tool shank extends, also preventing the cutting tool from translating axially further into the collet chuck during cutting.

Although the collet nut and associated tapers of the collet and collet chuck portion of the tool holder do compress and clamp cutting tool within the spring collet, the strength with which the spring collet clamps the cutting tool is sometimes insufficient. The cross sectional shapes of the cutting tool and the through hole of the tool holder are round, so a relative rotation (twist) between the tool holder and the cutting tool may still occur during use. For example, the relatively small diameter of the shank of the cutting tool that is held by the interior bore of the collet may, under sufficient operating torque, lead to the cutting tool shank rotating within the collet. Such rotation can also cause axial pullout of the cutting tool from the tool holder because of the twisting action.

Rotational slippage and axial pullout can cause damage to the cutting tool and/or work piece. To avoid rotational slippage and axial pullout, feed rates and RPM must be limited, which is often impractical. Therefore, an improved the conventional machine tool holding assembly that prevents tool rotation is desired. This is also true with collets that are other than the spring type.

To overcome the shortcomings, the present invention provides a machine tool holder and assembly to mitigate the aforementioned problems.

### SUMMARY

The present invention may comprise one or more of the features recited in the attached claims, and/or one or more of the following features and combinations thereof.

The main objective of the invention is to provide a machine tool holder assembly that prevents a relative rotation between a cutting tool and a tool holder collet.

A machine tool assembly has a tool holder, a cutting tool, a collet, and a collet nut. The tool holder defines a keyed recess having multiple corners and/or multiple flats formed around an inner surface of the keyed recess. The keyed recess can be integral with the tool holder or can be a separate positioning chuck rotationally and axially secured within the tool holder. The cutting tool is inserted into the collet and has multiple edges and/or multiple flats formed on a keyed end of shank that are matingly received by the keyed recess to prevent relative rotation between the tool holder and the cutting tool and make the cutting tool rotationally and axial fixed within the tool holder. The keyed recess can include a spacer preventing the keyed end of the cutting tool from contacting a base of the keyed recess, thereby preventing radial misalignment of the cutting with the axis of the tool holder from the axial translation and force applied during tightening of the collet nut and collet.

The cutting tool has multiple edges and intervening flats formed on the machine tool end of its shank. When inserted within the collet and into the positioning chuck, the multiple edges of the cutting tool abut with the multiple corners of the keyed recess, which generally can includes the intervening flats on the machine tool end of its shank abutting flats formed between the multiple corners of the keyed recess. Because the cross sectional shape of the keyed recess is multilateral and has multiple corners which the multiple edges abut, the combination of the corners and the edges prevent relative rotation between the tool holder and the cutting tool, whether the keyed end matches the keyed recess, or simply mates with it. Clamping of the collet onto the cutting tool shank centers the cutting tool within the tool holder and prevents axial movement of the cutting tool relative to the tool holder.

One illustrative embodiment of a machine tool assembly includes a cylindrical tool holder having a connecting section, a collet section opposite to the connecting section, a flange section located between the connecting section and the collet section, and a through hole formed axially through the connecting section, the flange section and the collet section; a positioning chuck mounted securely in the through hole of the tool holder and having a first end, a second end opposite to the first end of the positioning chuck, an external threaded part formed around the first end of the positioning chuck and screwed in the through hole of the tool holder, and a keyed recess axially formed in the second end of the positioning chuck and having a non-circular cross section, an inner surface. and multiple corners formed around the inner surface of the keyed recess at intervals, a cutting tool inserted into the through hole of the tool holder and having a cutting area located outside the collet section; a keyed end being opposite to the cutting area and having an outer surface and multiple edges which are formed on the outer surface of the keyed end and abut the corners, and a shank formed between the cutting area and the keyed end; and a collet mounted in the through hole of the tool holder at the collet section and mounted securely around the shank of the cutting tool.

The machine tool holder can further include a spacer, and a counterbore defined in the center of the base of the keyed recess, the counterbore sized to receive a portion of the length of the spacer. The keyed end of the cutting tool can contact the spacer, thereby preventing the keyed end of the cutting tool from contacting the base of the keyed recess.

The keyed end of the cutting tool may have a cross sectional shape the same as that of the keyed recess, and the edges can respectively abut the corners. The positioning chuck can include a coolant hole axially formed through the positioning chuck and communicating with the keyed recess. The cutting tool can include a cutting tool aperture formed through the cutting tool and communicating with the keyed recess. The through hole of the tool holder can have a first segment axially formed through the connecting section and screwed securely on the external threaded part, and a second segment axially formed though the collet section and having a diameter larger than that of the first segment and a bottom, and the tool holder can have an annular abutting surface formed on the bottom of the second segment of the through hole of the tool holder and abutted by the positioning chuck.

The cross sectional shape of the keyed end can be rectangular and have four edges correspondingly implemented. Alternatively, the cross sectional shape of the keyed end can be triangular and three edges correspondingly implemented.

The positioning chuck can have a coolant hole axially formed through the positioning chuck and communicating with the keyed recess. The cutting tool can have a cutting tool aperture formed through the cutting tool and communicating with the keyed recess. The through hole of the tool holder can have a first segment axially formed through the connecting section and screwed securely on the external threaded part, and a second segment axially formed though the collet section and having a diameter larger than that of the first segment and a bottom, and the tool holder can have an annular abutting surface formed on the bottom of the second segment of the through hole of the tool holder and abutted by the positioning chuck.

Additional features of the disclosure will become apparent to those skilled in the art upon consideration of the following detailed description and drawings of the illustrative embodiments.

### BRIEF DESCRIPTION OF THE DRAWINGS

FIG. 1 is a perspective view in partial longitudinal section of a first embodiment of a machine tool assembly in accordance with the present invention;

FIG. 2 is an exploded perspective view in partial longitudinal section of the machine tool assembly in FIG. 1;

FIG. 3 is a cross sectional side view of the machine tool assembly in FIG. 1; and

FIG. 4 is a cross sectional side view of a portion of a second embodiment of a machine tool assembly in accordance with the present invention.

### DETAILED DESCRIPTION

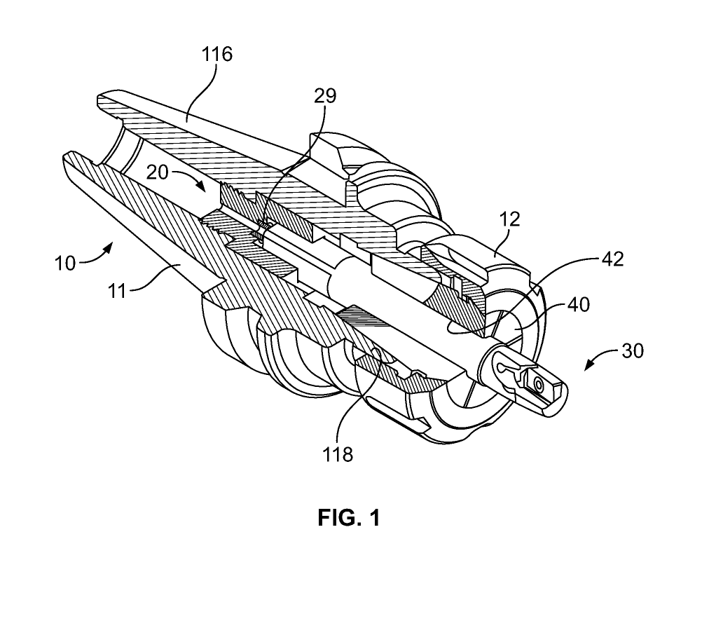

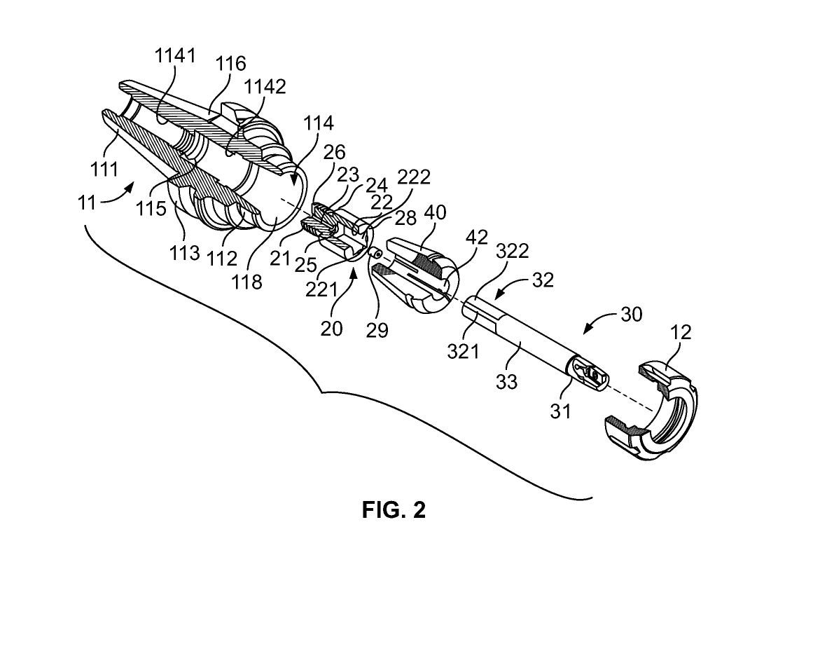

With reference to FIGS. 1 to 3, a first illustrative embodiment of a machine tool holder and assembly in accordance with the present invention comprises a tool holder 10, a positioning chuck 20, a cutting tool 30 and a collet 40.

The cylindrical tool holder 10 has a main body 11 and a collet nut 12. The main body 11 has a connecting section 111, a collet section 112, a flange section 113, a though hole 114, and an abutting surface 115. The connecting section 111 of the main body 11 is defined at an opposite machine tool end from the collet section 112. The flange section 113 is located between the connecting section 111 and the collet section 112. The outer surface 116 of the connecting section 111 is tapered or semi-conical for engagement with a machine spindle (not shown). The collet section 112 is defined at a distal or cutting tool end. The interior surface of the collet section 112 portion of the through hole 114 defines a collet receptacle (chuck) 118 for receiving the collet 40. With reference to FIGS. 1 to 3, the collet 40 is mounted in the through hole 114 at the collet section 112 and is mounted securely around the shank 33 of the cutting tool 30. The collet 40 may be conventional and requires no modification, for example a standard sealed or unsealed spring collet.

The hole 114 is optionally a through hole that provides not only the collet receptacle 118, but also a coolant flow path from the machine spindle (not shown) to the collet 40 and/or the cutting tool 30. In the illustrated embodiment, the through hole 114 is axially formed through the connecting section 111, the flange section 113, and the collet section 112.

The through hole 114 in the illustrative embodiment includes a first segment 1141 and a second segment 1142. The first segment 1141 is axially formed through the connecting section 111. The second segment 1142 is axially formed though the collet section 112 and has a diameter larger than that of the first segment 1141. An annular abutting surface 115 is formed on the bottom of the second segment 1142 of the through hole 114, at the intersection with the first segment 1141.

The collet nut 12 is mounted on a distal end of the collet section 112. As the collet nut 12 is tightened onto the tool holder body 11, is translates the collet 40 axially toward the connecting section 111, deeper into the tapered collet receptacle 118, thereby partially radially collapsing the collet, radially compressing the interior bore 42 onto the shank 33 of the cutting tool 30, thereby securing the cutting tool relative to the tool holder 10. As the interior bore 42 compresses onto the shank 33 and the collet nut 12 is further tightened, the tool 30, including the shank 33 may also translate deeper into the tool holder body 11. Further features of the tool holder 10, except various features of the through hole 114 and keyed recess 22, may be conventional and a further detailed description is therefore omitted.

The positioning chuck 20 is mounted securely in the through hole 114 of the tool holder 10. A shoulder 24 is defined between a first end 26 and a second end 28 of the positioning chuck 20. The shoulder 24 of the chuck 20 can abut the abutting surface 115, thereby securing the positioning chuck 20 rotationally and axially relative to the tool holder body 11.

The positioning chuck 20 may be similar to prior art set screws used to limit axial depth of the cutting tool shank 33 in the tool holder body 11; however, a keyed recess 22 is axially formed in the second end 28 of the positioning chuck 20. The keyed recess 22 has an inner surface defining multiple corners (or points) 221 and/or interleaving multiple flats 222, each at intervals around the interior circumference of the keyed recess, and thus the keyed recess 22 has a non-circular cross-section. The multiple corners 221 and multiple flats 222, collectively (whether one or both are present) referred to as a keyed recess, are axially aligned with the through hole 114. The positioning chuck 20 can also include a coolant hole 23 axially formed through the positioning chuck 20 and communicating with the keyed recess 22, thus allowing for liquid coolant flow from the machine spindle (not shown) to the cutting tool 30.

An external thread 21 is formed around the first end 26 of the chuck 20 and is screwed into a matching threaded portion of the first segment 1141 of the through hole 114. The external thread 21 must be oriented so that position chuck 20 will tighten and not loosen during cutting. Because machine tool spindles typically rotate clockwise, the external thread 21 and associated matching threaded portion of the first segment are typically right-hand threads (which is opposite of that typically used for prior art set screws). The chuck 20 can be rotated so that external threads 21 engage with the threaded portion of the first segment 1141 until shoulder 24 contacts annular abutting surface 115, effectively securing the chuck 20 rotationally and axially relative to the through hole 114 and tool holder body 11.

With reference to FIGS. 1 to 3, the cutting tool 30 is mounted securely in tool holder 10, extending through the collet nut 12, into the through hole 114, and includes a cutting end 31, a shank 33, and a keyed end 32 defined at an end of the shank 33 opposite the cutting end. Features related to keyed end 32 are sometimes referred to as the driving end or tang on tapping tools. When assembled with the tool holder 10, the cutting end 31 is located outside the collet section 112 and the keyed end 32 and at least a portion of the shank 33, is located within the tool holder 10. In the illustrative embodiment, the cutting tool 30 with the special features of the keyed end 32 is a milling cutter, in this example, a milling cutter having an indexable insert, for example, an end mill.

The keyed end 32 has an outer surface defining multiple edges (or points) 321 and/or interleaving multiple flats 322, each at intervals around its periphery. The edges 321 can be formed by having a tool shank 33 having a single diameter and forming flats 322 around the circumference of the shank adjacent the keyed end 32. The multiple edges 321 and multiple flats 322, collectively (whether one or both are present) referred to as the keyed end, are axially aligned with the shank 33. The keyed recess 22 in positioning chuck 20 is sized and the multiple corners 221 and/or flats 222 formed to receive the keyed end 32 such that the edges 321 abut the corners 221, and/or the flats 322 abut the flats 222, thus prevented relative rotation of the positioning chuck 20 and the cutting tool 30. Additionally or alternatively, surfaces between the edges 321 of keyed end 32 and surfaces between corners 221 of keyed recess 22 are cooperatively adjacently positioned to prevent relative rotation. Specifically, depending to the relative cross-sections and fit, the engagement of the keyed end 32 into the keyed recess 22 may impede all relative rotation, or may allow only partial rotation before abutting of the edges 321 and corners 221 and/or associated flats 322 and 222 prevents further rotation. The surfaces between edges 321 and corners 221 may be, but are not required to be planar surfaces, so long as the cooperation of features of the keyed recess 22 and keyed end 32 prevent all relative or at least continuing rotation.

The keyed end 32 can have a cross-sectional shape the same as that of the keyed recess 22, so the edges 321 respectively abut the corners 221. For example, the cross sectional shape of the keyed end 32 can be rectangular and four edges 221. Alternatively, the cross-sectional shape of the fixing segment 1141 may be different from that of the keyed end 32. For example, the cross-sectional shape of the fixing segment 1141 can be hexagonal and the cross sectional shape of the keyed end 32 can be triangular. The present invention does not limit the cross sectional shapes of the keyed end 32 and the keyed recess 22 as a number of geometrically differing, but engage cross sections are known in the art that prevent continuing rotation of the cutting tool relative to the keyed recess 22 and thus the machine tool body 11. In the illustrative embodiment, the keyed recess 22 and keyed end 32 each have four matching corners (or points) 221 and 321 formed by interleaving matching flats 222 and 322; however, other numbers of corners and or flats, or other shapes and features, for example, as are known in the fastening and driving art, can be used, as long as the coupling of the keyed recess 22 and keyed end 32 prevents relative rotation of the cutting tool 30 about the machine tool body 11.

Because cross sectional shape of the keyed recess 22 of the positioning chuck 20 is multilateral and has multiple corners 221 which the edges 321 of the cutting tool 30 abut, the combination of the corners 221 and the edges 321 and/or the flats 222 and 322 prevent relative rotation between the tool holder 10 and the cutting tool 30, making the cutting tool 30 securely rotationally fixed with the tool holder 10 and thus preventing rotational slippage, axial pullout, and related problems.

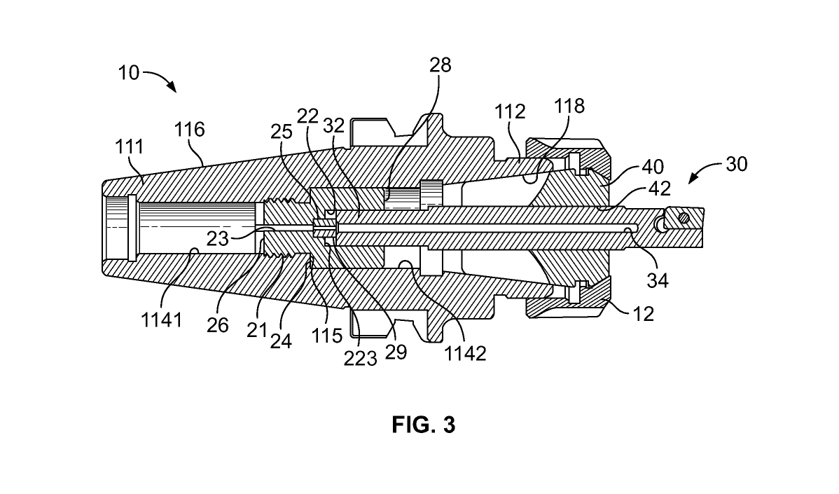

As shown in FIG. 3, the cutting tool 30 can have a coolant aperture 34 formed through the cutting tool 30 and communicating with the keyed recess 22. Accordingly, coolant supplied by the machine spindle (not shown) can flow through the coolant hole 23 in the positioning chuck 20 and through the cutting tool aperture 34 in the cutting tool 30, to cool the cutting tool 30 and a work piece.

Referring to FIG. 3, optionally, in the illustrative embodiment, a spacer 29 is positioned between the end of the keyed end 32 of the cutting tool 30 and the base 223 of the keyed recess 22. The spacer 29 prevents the end of the keyed end 32 of the cutting tool 30 from contacting the base 223 of the keyed recess 22, and is made from a slightly axially compressible material, for example, a length of poly tubing, for example, but not limited to, polyethylene, polypropylene, or polyurethane tubing. If keyed end 32 were to contact the base 223 during the tightening of the collet nut 12 on the collet 40 and onto the shank 33 of the tool 30, as the collet 40 is further tightened, the resulting axial translation of tool 30 toward the base 223 can induce axial misalignment of the cutting tool 30 with the tool holder 10, the shank 33 being radially off of machine center, cutting run out, vibration, and/or excessive tool cutter wear. The spacer serves to initially axially position the keyed end of the cutting tool distal enough from the base so as to prevent the keyed end from contacting the base of the keyed recess as the cutting tool translates toward the base during tightening of the collet nut.

In the illustrative embodiment, the spacer 29 is received by a counterbore 25 formed in the center of the base 223 of the keyed recess 22. The counterbore 25 can be sized in depth to receive a portion of the length of the spacer 29 and can be sized in diameter to receive the spacer 29. For example, the diameter of the counterbore 25 can be a press fit or other fit so that spacer 29 is retained in counterbore 25 once inserted into the counterbore, and a length of the spacer 29 that prevents the cutting tool 30 from contacting the base 223 can extend outside of counterbore 25, for example, at least about 0.010 inches.

For example, the length of spacer 29 extending from the counterbore 25 and the material selected for spacer 29 should allow some compression, and resistant excess compression that would allow the cutting tool 30 to contact base 223. Specifically, preventing contact of cutting tool 30 and base 223 upon the collet 40 and collet nut 12 being loosely assembled to the tool holder 10, the cutting tool 30 inserted within the collet 40 so that the keyed end 32 extends into the keyed recess 22 and into contact with the spacer 29, and the collet nut 12 tightened sufficiently on the collet 30 and cutting tool shank 33 to perform cutting, for example, torque to about 140 ft/lbs.

Using tubing as the material for spacer 29, or otherwise providing an axial coolant passage though the spacer, provides the added benefit of allowing the coolant or other fluid to be transmitted from coolant hole 23 in the positioning chuck 20 to the coolant aperture 34 in the cutting tool 30. Because the spacer 29 will slightly compress between the cutting tool 30 and positioning chuck 20 as the collet nut 12 is tightened, axially translating the cutting tool 30 toward base 115, for example, about 0.003 to about 0.009 inches, the opposite ends of the spacer 29 will form a seal between coolant hole 23 and coolant aperture 34. This seal prevents fluid from escaping into the spaces between the features of the keyed end 32 and the keyed recess 22 and from flowing on around the shank 33 and toward the collet 40. This added advantage of fluid sealing may allow the use of a standard non-sealed collet 40, rather than a standard steel sealed or other type of sealed collet that would otherwise be required to ensure fluid is transmitted through the aperture 34 in the cutting tool 30, rather than through the collet.

Alternatively, the base 223 of the keyed recess can provide a stop surface, whether compressible or not compressible, that prevents axial translation of the cutting tool 30 toward the connecting section 111 (machine spindle end), thus fixing the cutting tool axial relative to the machine tool holder body 11.

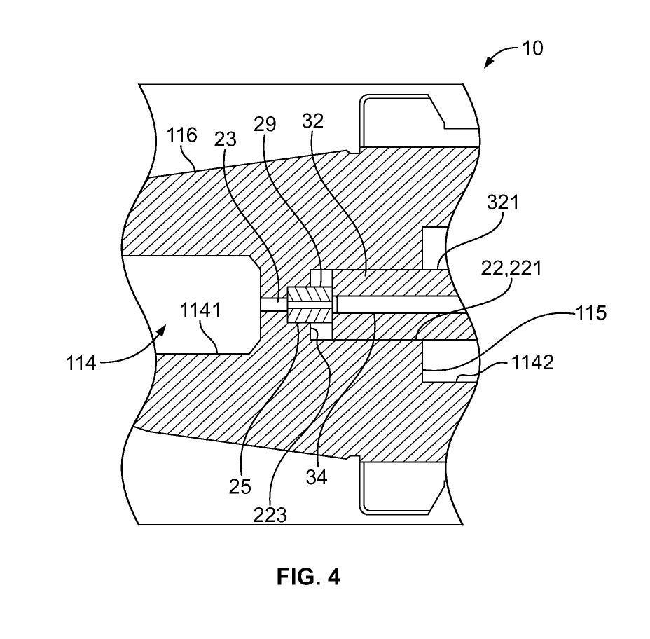

Referring to FIG. 4, a portion of a second illustrative embodiment of the machine tool holder 10′ is shown to illustrate an alternative feature of the keyed recess 22. Specifically, rather than the keyed recess 22 being formed in a separate positioning chuck 20 as discussed above, the keyed recess 22 can be integral with the tool holder 10′. More specifically, the keyed recess 22 can be formed by the tool holder body 11 along a portion of the through hole 114, and/or the keyed recess 22 can be in communication with the collet receptacle 118. Further features of keyed recess 22 discussed herein can similarly be defined integrally by the tool holder body 11, including the multiple corners 221, flats 222, bottom 223, counterbore 25, and cooling hole 23.

While the invention has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the claims and summary are desired to be protected.

1. A machine tool holder for receiving a cutting tool having a keyed end, comprising:
a machine tool end;
a cutting tool end;
a collet receptacle for receiving a collet and the cutting tool in the cutting tool end; and
a keyed recess defined between the machine tool end and the collet, the keyed recess:
rotationally and axially fixed with the tool holder;
in communication with the collet section; and
defines a base and an inner surface axially aligned with the collet receptacle, the inner surface having a non-circular cross section along its length, shaped to receive the keyed end of the cutting tool; and,
wherein the keyed end of the cutting tool received within the keyed recess prevents rotation of the cutting tool relative to the tool holder.

2. The machine tool holder of claim 1, further comprising a spacer extending between the base of the keyed recess and the keyed end of the cutting tool, and wherein the spacer is compressible and axially positions the keyed end of the cutting tool to prevent the keyed end from contacting the base of the keyed recess.

3. The machine tool holder of claim 2, further comprising a counterbore defined in the center of the base of the keyed recess, the counterbore sized to receive a portion of the length of the spacer.

4. The machine tool holder of claim 3, further comprising a positioning chuck having a first end and a second end opposite to the first end, and wherein:
the positioning chuck is rotationally fixed within the tool holder between the machine tool end and the collet receptacle; and
the keyed recess is defined by the second end of the positioning chuck.

5. The machine tool holder of claim 4, wherein:
the cutting tool defines a coolant aperture;
the positioning chuck defines a coolant hole axially through the positioning chuck and communicating with the keyed recess; and,
the spacer defines a coolant passage axially though the spacer and provides a sealed fluid conduit between the coolant hole and coolant aperture.

6. The machine tool holder of claim 4, further comprising a threaded receptacle defined axially by the tool holder between the machine tool end and the collet receptacle; and wherein:
the positioning chuck further includes an external thread formed around the first end of the positioning chuck; and
the external thread is screwed in the threaded receptacle, thereby axially and rotationally fixing the keyed recess relative to the tool holder.

7. The machine tool holder of claim 4, further comprising a through hole defined axially by the tool holder through the connecting section and collet receptacle, and wherein:
the through hole defines a first segment axially formed through the connecting section;
the through hole further defines a second segment axially formed though the collet section and having a diameter larger than that of the first segment and a bottom; and
the tool holder defines an annular abutting surface formed on the bottom of the second segment of the through hole of the tool holder and abutted by the positioning chuck.

8. The machine tool holder of claim 7, wherein the first segment defines a threaded receptacle for receiving the positioning chuck.

9. The machine tool holder of claim 1, wherein the cross sectional shape of the inner surface is rectangular and the number of plurality of corners is four.

10. The machine tool holder of claim 1, wherein the cross sectional shape of the inner surface is triangular and the number of plurality of corners is three.

11. The machine tool assembly as claimed in claim 1, wherein the keyed recess defines a coolant hole axially formed therein and in communication with the connecting section.

12. A machine tool holder assembly, comprising:
a machine tool holder having:
a machine tool end;
a cutting tool end;
a collet receptacle for receiving a collet and the cutting tool in the cutting tool end; and
a keyed recess defined between the machine tool end and the collet, the keyed recess:
rotationally and axially fixed with the tool holder;
in communication with the collet section; and
defines a base and an inner surface axially aligned with the collet receptacle, the inner surface having a non-circular cross section along its length and shaped to receive the keyed end of the cutting tool; and,
a collet positioned in the collet receptacle;
a cutting tool having a shank and a keyed end defined by the end of the shank;
a collet nut for retaining the collet and cooperating with the collet receptacle to clamp the cutting tool shank within the collet; and,
wherein the keyed end of the cutting tool mates with the keyed recess of the machine tool holder, thereby preventing rotation of the cutting tool relative to the machine tool holder.

13. The machine tool holder of claim 12, further comprising:
a spacer; and,
a counterbore defined in the center of the base of the keyed recess, the counterbore sized to receive a portion of the length of the spacer; and,
wherein the spacer contacts the keyed end of the cutting tool, thereby preventing the keyed end of the cutting tool from contacting the base of the keyed recess.

14. The machine tool holder assembly of claim 13, further comprising a positioning chuck having a first end, a second end opposite to the first end of the positioning chuck, and wherein:
the positioning chuck is rotationally fixed with the tool holder between the connecting section and collet receptacle; and
the keyed recess is defined by the second end of the positioning chuck.

15. A machine tool holder for receiving a cutting tool having a keyed end, comprising:
a machine tool end;
a cutting tool end;
a collet receptacle for receiving a collet and the cutting tool in the cutting tool end; and
a keyed recess defined between the machine tool end and the collet, the keyed recess:
rotationally and axially fixed with the tool holder;
in communication with the collet section; and
defines a base and an inner surface axially aligned with the collet receptacle, the inner surface having a non-circular cross section along its length, shaped to receive the keyed end of the cutting tool; and,
a spacer;
a counterbore defined in the center of the base of the keyed recess, the counterbore sized to receive a portion of the length of the spacer; and,
wherein:
the spacer contacts the keyed end of the cutting tool, thereby preventing the keyed end of the cutting tool from contacting the base of the keyed recess; and,
the keyed end of the cutting tool received within the keyed recess prevents rotation of the cutting tool relative to the tool holder.

16. The machine tool holder of claim 15, further comprising a positioning chuck having a first end and a second end opposite to the first end, and wherein:
the positioning chuck is rotationally fixed within the tool holder between the machine tool end and the collet receptacle; and
the keyed recess is defined by the second end of the positioning chuck.

17. The machine tool holder of claim 16, wherein:
the cutting tool defines a coolant aperture;
the positioning chuck defines a coolant hole axially through the positioning chuck and communicating with the keyed recess; and,
the spacer defines a coolant passage axially though the spacer and provides a sealed fluid conduit between the coolant hole and coolant aperture.
